(19) United States
(12) Patent Application Publication
(10) Pub. No.: US 2022/0144094 A1
(43) Pub. Date: May 12, 2022

(54) Rechargeable Battery With Monitoring Device

(71) Applicant: Bayerische Motoren Werke Aktiengesellschaft, Muenchen (DE)

(72) Inventors: Franz FUCHS, Muenchen (DE); Sebastian SCHARNER, Tuerkenfeld (DE); Jan Philipp SCHMIDT, Holzmaden (DE)

(21) Appl. No.: 17/427,343

(22) PCT Filed: Apr. 15, 2020
(86) PCT No.: PCT/EP2020/060508

§ 371 Date: Jul. 30, 2021

(30) Foreign Application Priority Data
May 17, 2019 (DE) 10 2019 113 065.4

(51) Int. Cl. B60L 3/00; H01M 10/48; B60L 50/64

(52) U.S. Cl. CPC B60L 3/0046; H01M 10/482; H01M 2220/20; B60L 50/64; H01M 10/486

(57) ABSTRACT

A rechargeable battery is to be installed in a passenger transport vehicle as storage for the drive energy thereof. The rechargeable battery includes a plurality of galvanic cells and sensors for monitoring the state of the individual cells for the purpose of generating warning messages concerning the failure of individual cells. One of the sensors is an infrared matrix sensor, wherein the acquisition range of the infrared matrix sensor includes an area on which surface sides of the plurality of individual cells lie adjacent to one another.

### BACKGROUND AND SUMMARY OF THE INVENTION

The invention relates to a rechargeable electric battery to be installed, in accordance with its designated use, as a storage unit for the drive energy thereof in a vehicle for passenger transportation.

In the case of a rechargeable battery of this type, the possibility of a “thermal runaway” cannot be ruled out entirely. Thermal runaway may occur if, in a volume region of the rechargeable battery, a temperature limit that is relevant in that respect is exceeded typically by a short circuit in a single galvanic cell. Due to the increased temperature, further reactions are triggered that further drive the temperature increase. Owing to the expansion of heat, larger volume regions are affected by the temperature increase, with the result that the quantity of reacting substances also increases.

For the purpose of being able to prevent such an event and, should it still occur, to keep consequential damages as small as possible, the state of the rechargeable battery is monitored using a variety of sensors. According to one aspect of this monitoring, an alert is automatically output to the vehicle occupants if an indication of thermal runaway of the rechargeable battery has been identified. It is important here that the alert is issued in terms of time as long as possible before the point in time at which the overheating spreads into the surrounding region of the rechargeable battery. According to what is known as a propagation test which is relevant in this respect, the period of time that begins with the alert and within which the overheated volume must be limited to the volume of the rechargeable battery is five minutes.

In the case of condition monitoring of the rechargeable battery by use of sensors, which must take place automatically for reasons of safety, the cell voltage of the individual galvanic cells of the rechargeable battery and, for in each case a small group of cells, the temperature are measured. The relevant indicators of danger are here a drop in the cell voltage, rapid temperature increase, and exceeding an upper temperature limit. In order to avoid false alarms and for reliably generating appropriate alerts, the measurement results of a plurality of sensors are logically linked to one another.

The temperature measurements are made outside the individual cell and in each case for a plurality of cells together. Due to the distance differences between the respective temperature sensor and the individual cells, the detection time for an increase in temperature varies from cell to cell. The greater the delay is with which an increase in temperature in a cell is detected, the more difficult it will be to exactly assign the error and consequently also to make the correct decision with respect to an alert and the more may be lost of the time period within which, after an alert, no fire and no explosion to the outside become active.

DE 10 2014 106 794 A1 proposes to monitor the rechargeable battery of an electrically operated industrial truck with the aid of a plurality of infrared sensors that are located above the cells of the rechargeable battery at a distance therefrom and detect any thermal radiation that may be emitted by the cells. The result of the sensors is obtained from the sum of the thermal radiation emitted by a plurality of cells together and substantially represents the average temperature of the rechargeable battery. The result is used only to allow a targeted reduction in the maximum output power or charging capacity of the rechargeable battery if the rechargeable battery exhibits an increased temperature. The objective of the measure is thus to extend the lifetime of the rechargeable battery.

The object on which the invention is based consists in improving the temperature monitoring of a rechargeable electric battery, which comprises a plurality of galvanic cells and serves as a storage unit carried along for the drive energy of a vehicle for passenger transportation, to the effect that a temperature increase of each individual cell can be reliably quickly ascertained better than until now and, at the same time, is assignable uniquely to the respective cell.

The proposal for achieving the object is to monitor the temperature of a plurality of cells of the rechargeable battery with the aid of a common infrared matrix sensor that is arranged at a distance from the cells and is oriented such that its capturing region encompasses a surface of the cells.

By orienting the capturing region of the infrared matrix sensor toward such a surface side of the rechargeable battery, at which surface sides of the individual cells of the rechargeable battery lie one next to the other, it is possible to identify, from the thermal images continuously repeatedly generated by the infrared matrix sensor, which cell at what point in time has what temperature on the observed surface side.

Compared to methods that have been used so far for ascertaining the temperature in the individual cells of a rechargeable battery, the following advantages are thus achieved:
The error detection time is significantly reduced. This increases the reliability that errors are identified before signal lines can be destroyed by the error that has occurred.
Due to the alert being able to be generated more quickly, it is easier to ensure that the minimum time period between alert and the earliest occurrence of fire or explosion can be observed. This makes it acceptable to save costs for the design safety of the rechargeable battery in other places.
The reliability of the assignment of temperature measurement results to individual cells is improved because the heat flow between the cells does not influence the measurement results and because the relevant infrared light also penetrates any clouds of dust or smoke well.
The propagation of thermal events in the rechargeable battery over time can be detected. The information in this respect is valuable for ascertaining the cause of these events and for the targeted further development of rechargeable batteries.

The invention will be illustrated on the basis of stylized drawings for an exemplary preferred embodiment of a rechargeable battery according to the invention.

### BRIEF DESCRIPTION OF THE DRAWINGS

FIG. 1 shows a partial sectional view from above of a rechargeable battery that is embodied in accordance with the invention.

FIG. 2 shows the rechargeable battery of FIG. 1 in a partial sectional view from the side.

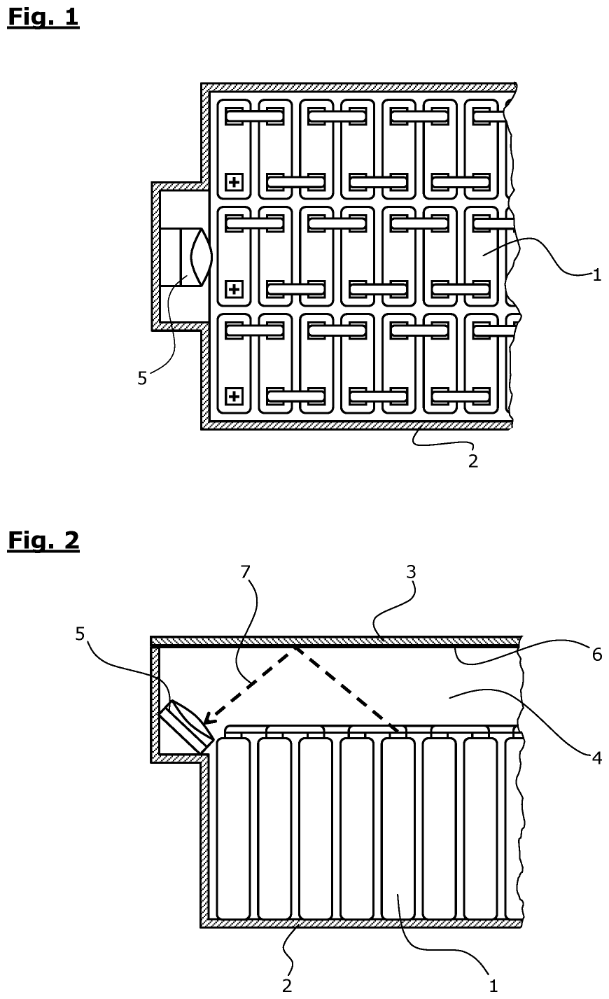

### DETAILED DESCRIPTION OF THE DRAWINGS

In the rechargeable battery according to an embodiment of the invention, which is shown in the drawings, a plurality of individual galvanic cells 1 with terminals that are in each case located at the top are located in multiple rows next to one another in a housing 2.

A cavity 4 is located between the cells 1 and the housing lid 3 that is located over the cells. The infrared matrix sensor 5 is arranged at a peripheral region of the cavity 4, preferably in a lateral projection of the housing 2.

The inner side of the housing lid 3, that is to say the surface thereof that is oriented toward the cavity 4, is provided with a layer 6 that is reflective for infrared radiation. The capturing region of the infrared matrix sensor 5 is oriented toward the reflective layer 6 and consequently also indirectly toward the cells 1.

Infrared light 7 emitted at the side of the cells 1 facing the cavity 4 as a result of the temperature thereof reaches the infrared matrix sensor 5 via the reflective layer 6 and leads in the infrared matrix sensor to a detection result that is transmitted—typically electronically—to a superordinate logic processing unit (not illustrated).

The operating principle of an infrared matrix sensor 5 should be briefly explained:

A simple infrared sensor is an electro-optical component having a sensor surface on which incident infrared radiation changes a quantifiable electric variable, such as a voltage or ohmic resistance, and in which an electrical signal is generated from this change.

An infrared matrix sensor 5 is an infrared sensor that is known per se and available for purchase and in which the sensor surface is divided into partial surfaces that are located next to one another, function largely independently of one another, and can provide detection results independently of one another, wherein the sensor surface is covered with respect to the light source by an optical lens, as a result of which incident infrared light is directed onto a precisely defined partial surface region of the sensor surface depending on the direction of incidence. It is thus possible to assign a temperature in the individual partial surfaces of the surroundings of the infrared matrix sensor 5 located in the capturing region of the infrared matrix sensor 5 to the electrical signals from the individual partial surfaces of the sensor surface. In other words, the infrared matrix sensor 5 generates a thermal image, in the form of electrical signals, of the surrounding region located in its capturing region.

Infrared matrix sensors 5, which are able to be advantageously used for this specific application and are based on the principle of thermocouples, have volumes for example in the range of a half cubic centimeter, image resolutions in the order of 100 pixels, and measurement frequencies of approximately 10 thermal images per second.

In the superordinate logic processing unit, the pieces of information from a plurality of individual measurement results from the infrared matrix sensor 5 and from measurement results of further sensors, such as in particular voltage sensors (not illustrated) that measure the voltages in the individual cells 1, are linked together logically. As was already mentioned in the introductory part, the decision is generated, as the essential result of this logic linking in each case for the current point in time, as to whether or not an alert indicating a dangerous defect in the rechargeable battery should be output.

Modifications or further developments of the illustrated construction of rechargeable batteries according to the invention, which likewise fall within the scope of the invention, will be briefly mentioned without any claim to completeness:

The capturing region of the infrared matrix sensor 5 can also be oriented directly toward the cells 1 rather than indirectly via the reflective layer 6. As compared to the embodiment with a reflective layer 6, in the case of an otherwise comparable design, the height of the cavity 4 in which the infrared light propagates from the cells 1 to the infrared matrix sensor 5 needs to be larger.

It is possible to save space in return for a somewhat greater production outlay by using a plurality of infrared matrix sensors 5 that are arranged spaced apart from one another and have a capturing region that is in each case oriented only toward a subset of the cells 1.

It is also possible to save space in return for a somewhat greater production outlay by not providing an empty cavity 4 for the transmission of infrared light from the cells 1 to the infrared matrix sensor 5 but rather a plurality of optical waveguides, wherein the individual optical waveguides lead from in each case an individual cell 1 to the infrared matrix sensor 5 used in common.

1.-5. (canceled)

6. A rechargeable electric battery for installation as a storage unit for drive energy of a vehicle for passenger transportation, the rechargeable electric battery comprising:
a plurality of galvanic cells; and
a plurality of sensors for monitoring states of the plurality of galvanic cells to generate alerts relating to failure of individual ones of the plurality of galvanic cells, wherein:
one of the plurality of sensors is an infrared matrix sensor, and
a capturing region of the infrared matrix sensor encompasses a surface at which surface sides of the plurality of galvanic cells are located next to each other.

7. The rechargeable electric battery according to claim 6, wherein the infrared matrix sensor is based on a principle of thermocouples.

8. The rechargeable electric battery according to claim 6, wherein:
a layer that is reflective for infrared radiation is located at a distance from the surface at which the surface sides of the plurality of galvanic cells are located next to each other, and
a propagation line of infrared radiation, which is to be detected by the infrared matrix sensor, extends from the plurality of galvanic cells to the layer and, from there, further to the infrared matrix sensor.

9. The rechargeable electric battery according to claim 7, wherein:
a layer that is reflective for infrared radiation is located at a distance from the surface at which the surface sides of the plurality of galvanic cells are located next to each other, and
a propagation line of infrared radiation, which is to be detected by the infrared matrix sensor, extends from the plurality of galvanic cells to the layer and, from there, further to the infrared matrix sensor.

10. The rechargeable electric battery according to claim 6, wherein:
the plurality of sensors comprises a plurality of spaced-apart infrared matrix sensors, and
a capturing region of each of the infrared matrix sensors extends only over a subset of the plurality of galvanic cells.

11. The rechargeable electric battery according to claim 6, wherein each of a plurality of optical waveguides extends from the infrared matrix sensor to an individual one of the plurality of galvanic cells.

12. The rechargeable electric battery according to claim 7, wherein each of a plurality of optical waveguides extends from the infrared matrix sensor to an individual one of the plurality of galvanic cells.
